(19) United States
(12) Patent Application Publication
(10) Pub. No.: US 2011/0032366 A1
(43) Pub. Date: Feb. 10, 2011

(54) METHODS OF STABILISING OPTICAL APPARATUS

(75) Inventor: Richard Arthur Lindsay, Suffolk (GB)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(73) Assignee: VITEC GROUP PLC, THE, Kingston Upon Thames, SURREY (GB)

(21) Appl. No.: 12/937,513

(22) PCT Filed: Apr. 15, 2009
(86) PCT No.: PCT/GB09/00981

§ 371 Date: Oct. 12, 2010

(30) Foreign Application Priority Data
Apr. 15, 2008 (GB) 0806871.0

(51) Int. Cl. H04N 5/228

(52) U.S. Cl. 348/208.4; 348/E05.031

(57) ABSTRACT

The disclosure relates to a method of eliminating unwanted movement from a static or moving image which is captured or created in an optical apparatus. The method comprises determining unwanted movement in the image, providing an image control feature which has a zero reference position and a range over which the control can be varied to counter in the moving or static image said unwanted movement and using said control feature to remove said unwanted movement in a static or moving image. Non-zeroing in the image control to said reference position is monitored and a restoration to the image control is applied to bias the control towards the reference position at a rate which is a function of the speed of movement of the image in the optical apparatus to minimise the effect of the restoration correction on the image.

This invention relates to stabilising optical apparatus and is particularly applicable to TV or video cameras, light directing devices (e.g. laser light devices) or sighting devices.

In our International Patent Publication No. WO 00/39498, we describe and illustrate an image stabilisation system in a mounting head for an optical apparatus such as a TV/video camera providing damped pan and tilt movement. A dynamic sensor in the form of an electronic gyroscope is mounted on the head to determine actual movement of the head and further electronic transducers in the form of encoders are incorporated across the dampers for the pan and tilt movement in the head to determine intended movement in each axis. Extraneous forces on the camera/mounting can cause unwanted movement to the camera. The difference between the actual and intended movements of the head is used to correct one of the position of the head, the optical axis or the image system for recording an image in the camera.

A problem with the above arrangement is that an accumulating offset will arise in the apparatus that applies the image correction whether it uses mechanical, optical or image processing correction.

This invention provides a method of eliminating unwanted movement from a static or moving image which is captured or created in an optical apparatus, the method comprising determining unwanted movement in the image, providing an image control feature which has a zero reference position and a range over which the control can be varied to counter in the moving or static image said unwanted movement and using said control feature to remove said unwanted movement in a static or moving image, wherein the method further comprises continuously monitoring non-zeroing in the image control to said reference position and applying a restoration to the image control to bias the control towards the reference position at a rate which is a function of the speed of movement of the image in the optical apparatus to minimise the effect of the restoration correction on the image.

In one method according to the invention, the unwanted movement may be determined from the actual image captured or created in the optical apparatus.

In an alternative method, the unwanted movement may be determined by measuring actual movement of the optical apparatus and intended movement of the optical apparatus, the difference being the unwanted movement of the apparatus which results in unwanted movement in the image captured or created in the apparatus.

In any of the above methods, the rate of the restoring correction may be a function of the rate of movement of the optical apparatus.

In the latter method, the rate of the restoring correction may be a function of the rate of movement of the optical apparatus and the field of view or projection of the apparatus.

Also, in any of the above methods, the rate of the restoring correction may be reduced if a significant part of the image is a subject which the apparatus is tracking or following. In that method, the speed of movement of said significant part of the image may be determined by image analysis or by manual intervention to minimise or prevent correction if the camera is tracking a subject.

In any of the above methods, when the image is stationary or near stationary any accumulated offset may be transferred to a memory and only newly arising offset may be acted on until motion of the apparatus resumes whereupon the accumulated offset is recovered from the memory to be acted on.

In a further general aspect of the invention, the optical apparatus may be mounted for pivotal movement with damping in one or more axes with electronic transducers to measure movement of the apparatus in each axis and to measure intended movement of the apparatus across the damping provided in each axis, the difference between the actual movement and the intended movement in each axis corresponding to the unwanted movement.

By way of the optical apparatus is a TV/video camera.

In the latter application of the method, said compensating movement may be applied to the camera, camera mounting, camera optics, image capture or to image playback.

In an alternative application, the optical apparatus may be a light directing device or a sighting apparatus.

The following is a description of some specific embodiments of the invention, reference being made to the accompanying drawings in which:

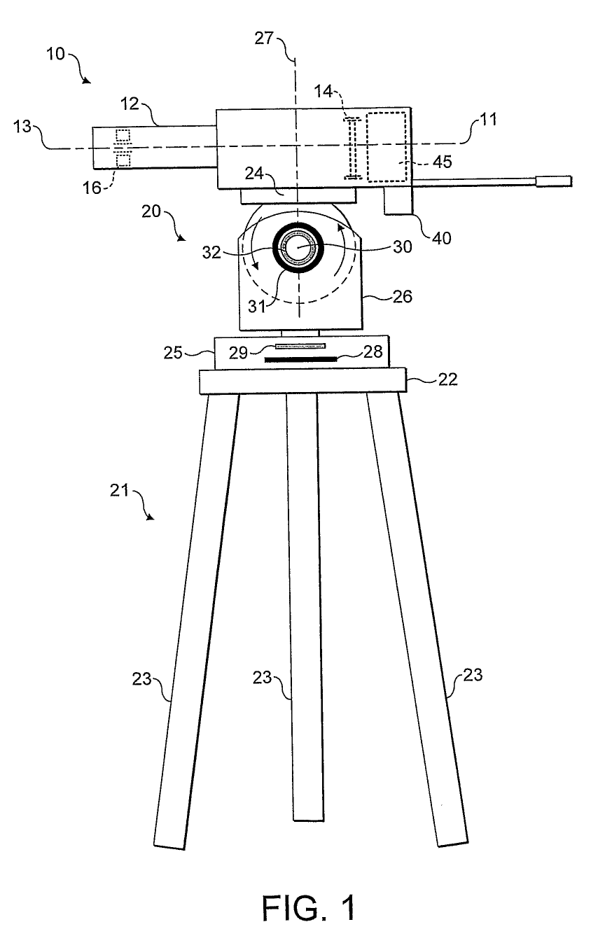

FIG. 1 is a diagrammatic side view of a TV/video camera supported on a pan and tilt head incorporating dampers in both axes with electronic transducers for measuring overall movement of the camera and input movement across the dampers in the pan and tilt axes with a microprocessor for determining unwanted movement for correction of the image produced by adjusting the optical path within the optics;

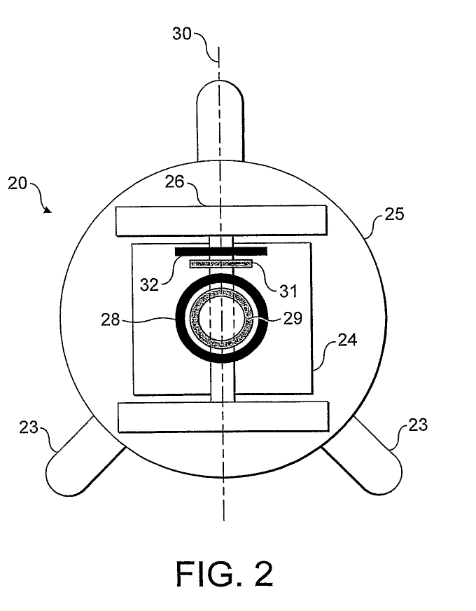

FIG. 2 is a plan view of the pan and tilt head with the camera omitted;

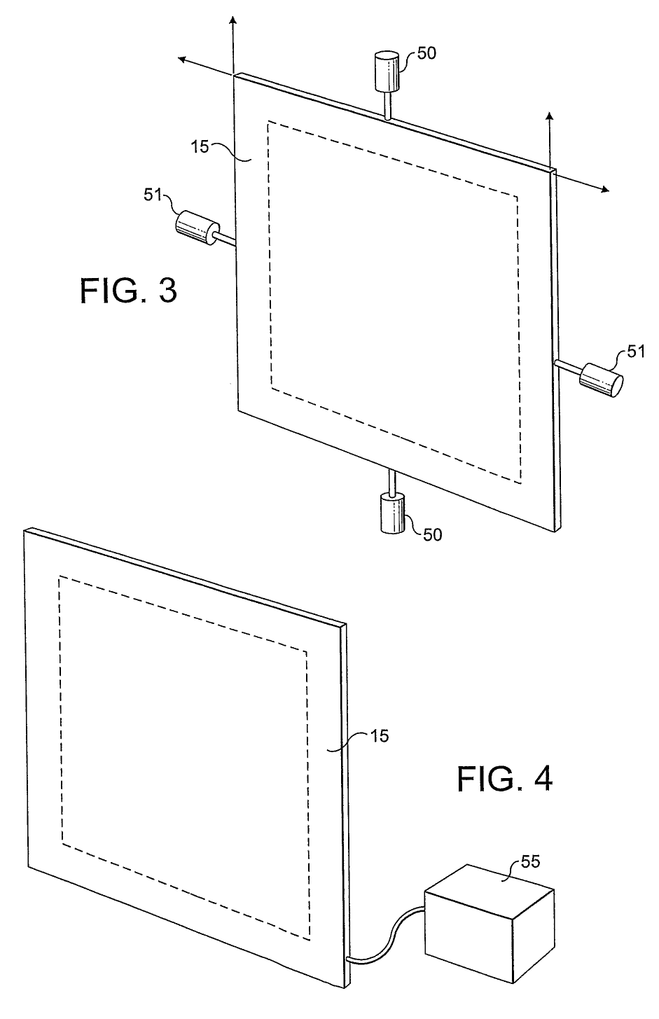

FIG. 3 is a perspective view of a CCD array for the camera with motorised units for adjusting the array vertically and horizontally with respect to the camera optical axis for image correction; and

FIG. 4 is an illustration of a further CCD array for mounting in the image plane in the camera with a control system for adjusting the effective part of the array with respect to the optical axis for correction of the image.

Referring firstly to FIGS. 1 and 2 of the drawings, there is shown a camera indicated generally at 10 having an optical axis 11, a lens system 12 with a lens axis 13 and an image plane 14 in which a CCD array 15 is mounted for capturing the image focused by the lens onto the array and converting the image into electronic data in known manner. The lens system has an adjustment arrangement 16 for adjusting the optical axis transversely to vary the location where the image is focused on the CCD array to correct for unwanted movement of the camera. Alternatively the CCD array may have an adjustable mounting which will be described later for adjusting the CCD array in relation to the lens axis as another way of correcting for unwanted camera movement.

The camera is mounted on a pan and tilt head indicated generally at 20 located on a tripod 21 having a head 22 and three divergent legs 23. The pan and tilt head has a platform 24 on which the camera is located and a base 25 which is mounted on the head 22 of the tripod.

The pan and tilt head has a body 26 mounted on the base 25 for rotation about a vertical axis indicated at 27 for pan movement of the camera. Rotation of the body about the base is controlled by a damper 28 (see FIG. 2) and an electronic encoder 29 acts between the base and body across the damper to measure rotation of the body with respect to the base.

The platform 24 of the pan and tilt head is mounted on the body 26 for rotation about a horizontal axis 30 to provide tilt movement for the camera. Again a damper 31 is provided for damping tilt movement of the platform 24 with respect to the body and an electronic encoder 32 measures movement of the platform with respect to the body across the damper 31.

By way of example, the dampers 28 and 31 may comprise multiple annular leaves mounted on the relatively rotating components of the pan and tilt head as described and illustrated in our EP-B-0850382.

A two axis electronic gyroscope 40 is mounted on the underside of the platform 11 to measure total movement of the camera in the pan and tilt axes whether it be intended movement imparted by the camera operator or unintended movement such as vibration transmitted through the ground into the tripod or wind action or other extraneous forces acting on the camera and causing inadvertent movement of the camera.

The pan and tilt encoders and the gyroscope are coupled to a microprocessor 45 in the camera which is programmed to calculate unwanted movement of a camera in each axis by taking from the actual movement of the camera in each axis as measured by the electronic gyroscope the movement as measured by the pan and tilt encoders. It will be appreciated that by measuring the movement in the mounting about the pan and tilt axes across the dampers, a representative value for the intended movement as applied to the camera by the camera operator is measured.

The difference between the actual and intended movement in each axis as computed by the microprocessor represents unwanted movement and signals are provided from the microprocessor to the lens adjustment system to provide an angular adjustment in the lens axis horizontally and/or vertically to compensate for the unwanted movement of the camera in the pan and tilt axes.

The microprocessor is programmed to calculate the unwanted movement periodically such as every millisecond.

FIG. 3 of the drawings shows a further development in which the CCD array 15 is movable horizontally and vertically by respective pairs of motor units 50, 51 acting on the sides and top and bottom of the array. The motor units are controlled by signals from the microprocessor. Moving the array laterally or vertically as required represents an alternative way of correcting the image as recorded by the camera to adjustment of the lens system. In a further arrangement shown in FIG. 4, the microprocessor is coupled to a unit 55 connected to the array of photo diodes to control the effective area in operation at any time. By adjusting the location of the effective area being used to record an image laterally or vertically in the overall array, it is possible to correct the image as recorded in the array for unwanted camera movement.

Further arrangements for correcting the unwanted camera movement are described in our International Patent Publication No. WO 00/39498 which include moving the camera bodily. Other arrangements are described in our International Patent Publication No. WO 2006/1175 in which the image and correction information from the transducers are supplied to a separate microprocessor which adjusts the image information to remove the unwanted movement as recorded in the image. This can be done immediately after the image has been recorded or the uncorrected image information and the correction information can be recorded separately and used to adjust the image only when the image is played back subsequently.

As indicated earlier accumulated offset e.g. due to transducer and computational errors will arise in the apparatus that applies the image correction, whether it is by mechanical, optical or image processing means. To counter the accumulation of offset in the correction apparatus it is necessary to apply a “homing” correction to bias continually the apparatus to move to its neutral, reference or datum position.

To achieve this with minimal apparent disturbances to the image, the rate at which the “homing” correction is applied is a function of the velocity of the image as captured in the camera. In this example the rate of homing correction applied is a function of pan or tilt speed and of optical field of view of the camera optics. Pan and tilt speeds can be measured by the encoders 29 and 32.

Little or no correction is applied when the image is stationary, whereas high rates of correction can be inconspicuously absorbed when the image is moving rapidly.

Thus when the image is stationary or a near stationary previously accumulated offset is held for subsequent correction. The control system determines that the image is stationary or near stationary and any accumulated offset is temporarily transferred to a storage field. Whilst the image is stationary only newly arising offset is corrected to maintain the image in the camera stationary. Once camera movement resumes, the control system recalls the stored offset to resume applying a corresponding correction for the accumulated offset as before.

1. A method of eliminating unwanted movement from a static or moving image which is captured or created in an optical apparatus, the method comprising determining unwanted movement in the image, providing an image control feature which has a zero reference position and a range over which the control can be varied to counter in the moving or static image said unwanted movement and using said control feature to remove said unwanted movement in a static or moving image, wherein the method further comprises continuously monitoring non-zeroing in the image control to said reference position and applying a restoration to the image control to bias the control towards the reference position at a rate which is a function of the speed of movement of the image in the optical apparatus to minimise the effect of the restoration correction on the image.

2. A method as claimed in claim 1, wherein the unwanted movement is determined from the actual image captured or created in the optical apparatus.

3. A method as claimed in claim 1, wherein the unwanted movement is determined by measuring actual movement of the optical apparatus and intended movement of the optical apparatus, the difference being the unwanted movement of the apparatus which results in unwanted movement in the image captured or created in the apparatus.

4. A method as claimed in claim 1, wherein the rate of the restoring correction is a function of the rate of movement of the optical apparatus.

5. A method as claimed in claim 4, wherein the rate of the restoring correction is a function of the rate of movement of the optical apparatus and the field of view or projection of the apparatus.

6. A method as claimed in claim 1, wherein the rate of the restoring correction is reduced if a significant part of the image is a subject which the apparatus is tracking or following.

7. A method as claimed in claim 6, wherein the speed of movement of said significant part of the image is determined by image analysis or by manual intervention to minimise or prevent correction if the camera is tracking a subject.

8. A method as claimed in claim 1 wherein when the image is stationary or near stationary any accumulated offset is transferred to a memory and only newly arising offset is acted on until motion of the apparatus resumes whereupon the accumulated offset is recovered from the memory to be acted on.

9. A method as claimed in claim 1, wherein the optical apparatus is mounted for pivotal movement with damping in one or more axes with electronic transducers to measure movement of the apparatus in each axis and to measure intended movement of the apparatus across the damping provided in each axis, the difference between the actual movement and the intended movement in each axis corresponding to the unwanted movement.

10. A method as claimed in claim 1, wherein the optical apparatus is a TV/video camera.

11. A method as claimed in claim 10, wherein said compensating movement is applied to the camera, camera mounting, camera optics, image capture or to image playback.

12. A method as claimed in claim 1, wherein the optical apparatus is a light directing device or a sighting apparatus.

13. A method of eliminating unwanted movement from a static or moving image which is captured or created in a TV/video camera, the method comprising determining unwanted movement in the image, providing an image control feature which has a zero reference position and a range over which the control can be varied to counter in the moving or static image said unwanted movement and using said control feature to remove said unwanted movement in a static or moving image, wherein the method further comprises continuously monitoring non-zeroing in the image control to said reference position and applying a restoration to the image control to bias the control towards the reference position at a rate which is a function of the speed of movement of the image in the TV/video camera to minimize the effect of the restoration correction on the image.

14. A method as claimed in claim 13, wherein the unwanted movement is determined from the actual image captured or created in the TV/video camera.

15. A method as claimed in claim 1, wherein the unwanted movement is determined by measuring actual movement of the TV/video camera and intended movement of the TV/video camera, the difference being the unwanted movement of the TV/video camera which results in unwanted movement in the image captured or created in the TV/video camera.

16. A method as claimed in claim 15, wherein the rate of the restoring correction is a function of the rate of movement of the TV/video camera and the field of view or projection of the TV/video camera.

17. A method as claimed in claim 13 when the image is stationary or near stationary any accumulated offset is transferred to a memory and only newly arising offset is acted on until motion of the TV/video camera resumes whereupon the accumulated offset is recovered from the memory to be acted on.

18. A method as claimed in claim 13, wherein the optical apparatus is mounted for pivotal movement with damping in one or more axes with electronic transducers to measure movement of the TV/video camera in each axis and to measure intended movement of the TV/video camera across the damping provided in each axis, the difference between the actual movement and the intended movement in each axis corresponding to the unwanted movement.
